(19) United States
(12) Patent Application Publication
(10) Pub. No.: US 2004/0078488 A1
(43) Pub. Date: Apr. 22, 2004

(54) Method and computer product for identifying and selecting potential e-mail reply recipients from a multi-party e-mail

(75) Inventor: Kyle N. Patrick, Pitt Meadows (CA)

Correspondence Address: David A. Mims, Jr., International Business Machines,, Intellectual Property Law, 11400 Burnet Road, Austin, TX, 78758, US

(73) Assignee: INTERNATIONAL BUSINESS MACHINES CORPORATION, ARMONK, NY

(21) Appl. No.: 10/671,059

(22) Filed: Sep. 25, 2003

(30) Foreign Application Priority Data
Oct. 17, 2002 (CA) 2,408,478

(51) Int. Cl. G06F 15/16

(52) U.S. Cl. 709/245

(57) ABSTRACT

Currently, e-mail systems automatically compose reply e-mail messages by entering the previous sender's address as the reply recipient address. The present invention provides a method to permit a recipient of a multi-party e-mail message to select recipients of a reply message by parsing the received message for e-mail addresses and forming a list from which the user can select reply recipients.

### TECHNICAL FIELD

The invention relates to the field of electronic mail (e-mail) communications and more particularly to a method for permitting a recipient of a multi-party e-mail to readily identify and select addresses of recipients for a reply e-mail.

### BACKGROUND ART

ARPANET Request for Comments #822, “Standard for the Format of ARPA Internet Text Messages” specifies a syntax for text messages that are sent among computer users within the framework of “electronic mail”. This is generally the standard adopted by current e-mail systems. The transmission protocol, Simpler Mail Transfer Protocol or SMTP, is defined by ARPANET RFC #821. In electronic mail systems, a sender creates the text of a message, selects attachments to the message if any, and addresses the message to one or more direct recipients, and may indicate some recipients as receiving copies of the message. The message is sent to the recipient or recipients via the Internet or other wide or local area network. In current e-mail systems, a sender creating an e-mail is provided with a header having a number of areas for entering data: such as “FROM:”, “TO:”, “CC:”, “BCC:”, “SUBJECT:”. The sender can type the addresses of one or more recipients into the “TO:”, “CC:” and “BCC:” boxes. When the original e-mail message is received by a recipient it displays the text of the message and an automatically-created header displaying the sender, recipients, subject, date and time. The recipient may then reply to the e-mail or forward it to other recipients. When the reply e-mail template is created, it automatically inserts the address of the sender of the message which is being replied to in the “TO:” box. A recipient of the forwarded or reply e-mail receives the original forwarded/replied message, generally marked in some way to distinguish it from an originating message. The recipient of the forwarded or reply e-mail also receives the automatically-created header displaying the sender, recipients, subject, date and time and the sending party's text message. In this way, when an original message has been replied to and/or forwarded a number of times, each time the recipient will receive a full history of the exchanges with e-mail address of the various parties involved in the exchanges. An e-mail which has been sent to multiple parties, or has been forwarded to or replied by multiple parties, is referred to herein as a multi-party e-mail. But when a reply message is created, unless the party replying wishes to reply to the address which sent the message to him/her, then the party replying must manually enter the reply-to e-mail addresses.

This current system may cause difficulties in a number of ways. Sometimes the e-mail message from sender A is intended for recipient B but is sent to a general mailbox address C which then forwards it to B, or to an address C which screens B's e-mail and then forwards it to B. B may compose a reply intended for A and inadvertently automatically replies to C rather than A. Similarly there may be a lengthy series of e-mail exchanges, one of which originated with A, and the latest of which is received by Z from Y. Z may wish to reply to A but to do so requires backtracking through the lengthy history to find and manually enter A's address, or he/she may inadvertently reply automatically to Y with a message intended for A.

There is therefore a need for a method for permitting the recipient of a multi-party email to easily select recipients of a reply message.

### DISCLOSURE OF INVENTION

The present invention therefore provides a method of selecting recipients of an e-mail message for transmission by a recipient computer in reply to a received e-mail message, the method comprising the steps of i) storing the received e-mail message in the memory of the recipient computer; ii) parsing the contents of the received email for e-mail addresses and forming a list of parsed e-mail addresses; iii) displaying the list of parsed e-mail addresses; and iv) forming a reply e-mail message to recipients selected from the list by the user.

The invention further provides a computer program product and an article comprising a computer readable modulated carrier signal for carrying out the method.

### BRIEF DESCRIPTION OF DRAWINGS

In drawings which disclose a preferred embodiment of the invention:

FIG. 1 is a schematic illustration of a computer network in which the present invention may be used;

FIG. 2 is a flow chart illustrating the method of the invention; and

FIGS. 3-5 are print-outs of a computer display illustrating the invention.

### BEST MODE(S) FOR CARRYING OUT THE INVENTION

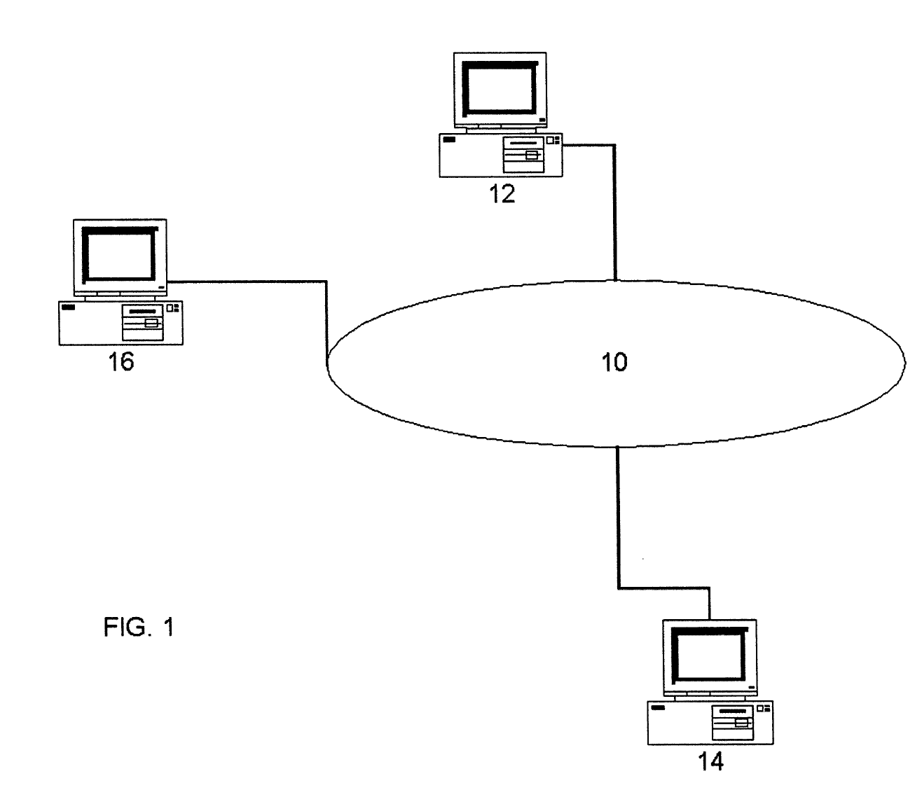

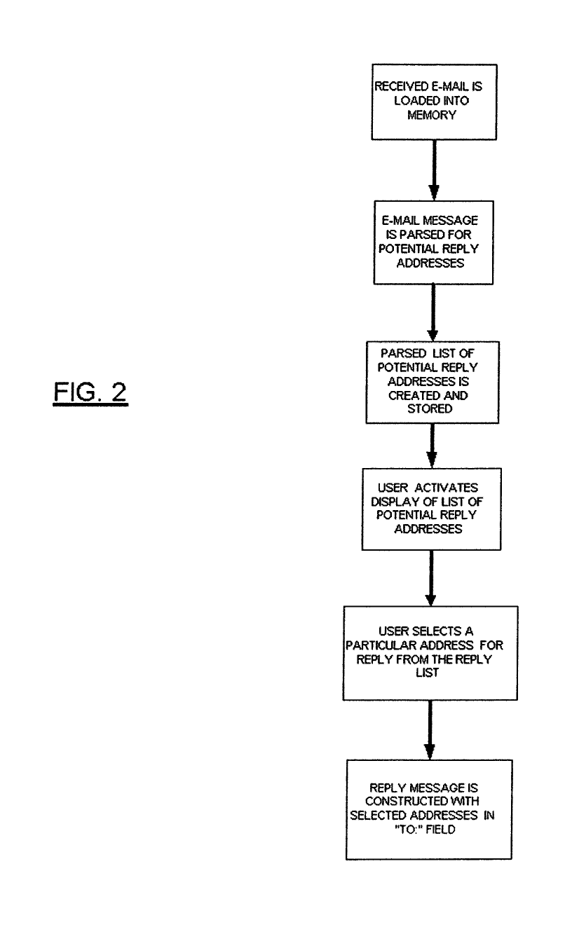

With reference to FIG. 1, a representative computer network 10 is illustrated comprising a number of e-mail client terminals 12, 14, 16 each having a central processor, display and memory and having electronic access to a computer network 10, such as the Internet, via e-mail servers which assign an e-mail address to each client terminal. Each client terminal 12, 14, 16 is provided with standard e-mail application software. It will be apparent that the invention may be used in any computer network or network of networks, whether local area or wide area. Client 12, whose e-mail address is jsmith@ca.ibm.com composes an e-mail message and addresses it to several recipients, including client 14 whose e-mail address is jdoe@ca.ibm.com by entering the respective e-mail addresses in “TO:”, “CC:” or “BCC:” boxes. Client 12 then forwards the message via the Internet to the recipient addresses. Client 14 receives the original message and forwards the message to client 16 whose address is bjones@ca.ibm.com. Upon receipt of the forwarded e-mail message at client 16, the message is loaded into the memory of client 16's computer and displayed to the user. Parsing software then parses the contents of the received e-mail for potential reply e-mail addresses, for example by locating the symbol “@” preceded by symbols and followed by text resembling a domain name. Other ways of parsing the e-mail addresses are also possible, such as by copying all text in “TO:” and “CC:” fields. A list of character strings which are likely e-mail addresses is then formed and stored in memory. Preferably the parsing step is carried out before the system displays the email for viewing. Alternatively the system may first load and display the e-mail for viewing and carry out the storage and parsing step when the user requests the list of potential reply e-mail addresses.

The system can then display the list of potential reply e-mail addresses to the user either automatically or in response to a user action. For example a button or pull-down menu may be provided which causes the list to be displayed. The user can then select those e-mail addresses from the list to whom the user wishes the reply message to be sent. The system then forms a response message based on the selected e-mail addresses such as by auto-populating SMTP headers and/or user interface graphical elements with the selected addresses in the “TO:” box. The user then sends a reply message to the selected e-mail addresses.

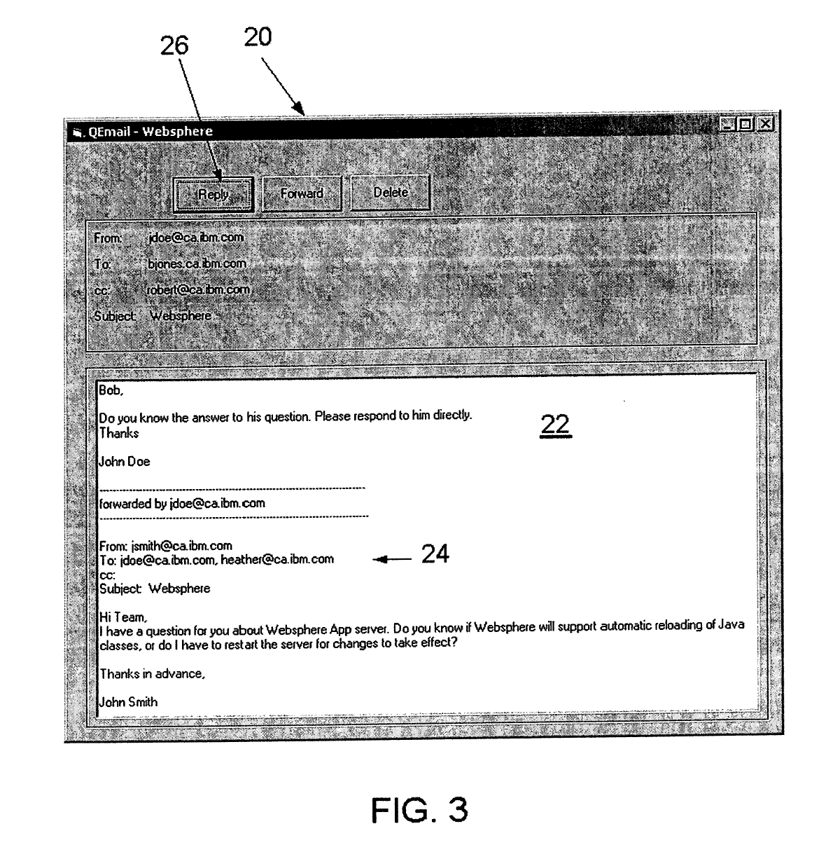

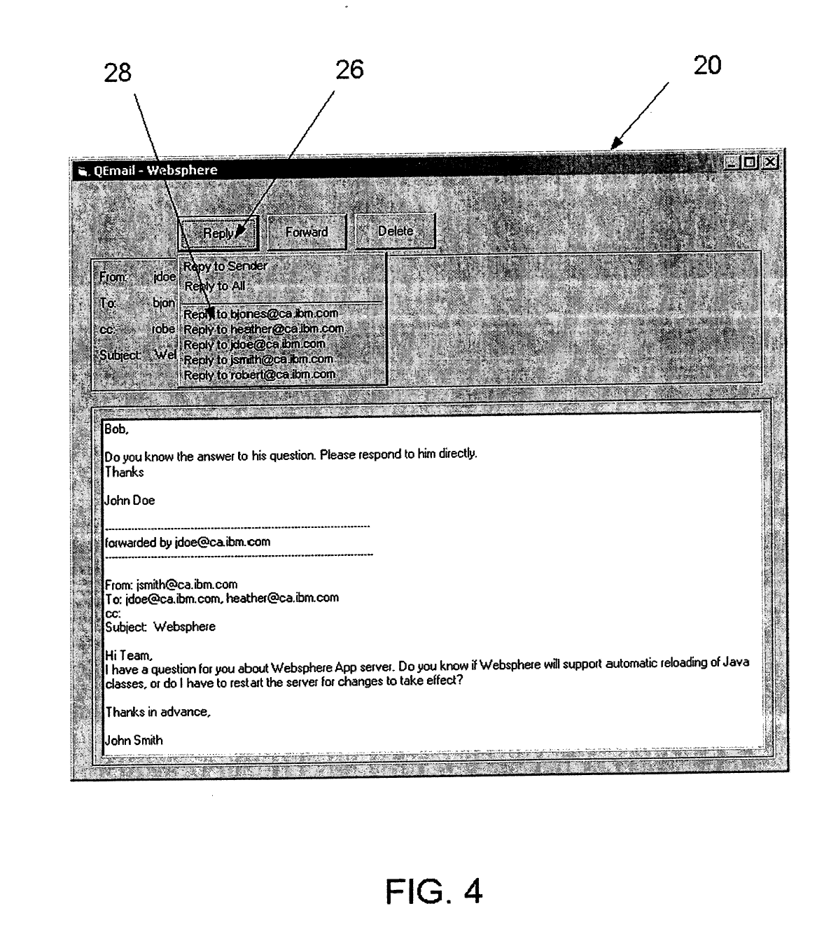

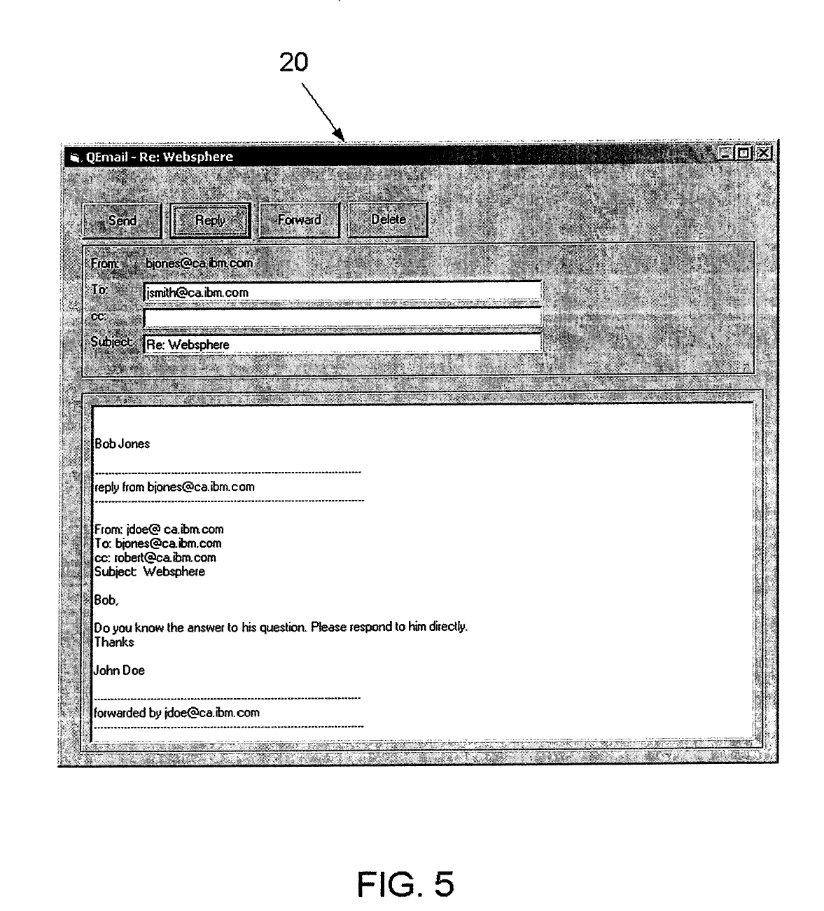

FIG. 3 illustrates a screen display 20 of a computer system adapted to carry out the invention. A message within message box 22, sent by jsmith@ca.ibm.com has been sent to multiple recipients 24, namely jdoe@ca.ibm.com and heather@ca.ibm.com. jdoe@ca.ibm.com has forwarded the message to bjones@ca.ibm.com with a copy to rjones@ca.ibm.com. The system parses the message 22 and pulls out all potential reply e-mail addresses and stores the list. When the user hits the reply button 26, as shown in FIG. 4 the system displays the list on pull-down menu 28 displaying all such e-mail addresses so that the user can select those addresses to which the user wishes the reply message sent. Such selection can be made by clicking the cursor on the selected address, for example. Once the selection has been made, the system formulates the reply e-mail header by inserting the selected addresses into the “TO:” box, as shown in FIG. 5 where the recipient bjones@ca.ibm.com has selected to reply to the originator of the message jsmith@ca.ibm.com.

The present invention is described above as a computer-implemented method. It may also be embodied as a computer hardware apparatus, computer software code or a combination of same. The invention may also be embodied as a computer-readable storage medium embodying code for implementing the invention. Such storage medium may be magnetic or optical, hard or floppy disk, CD-ROM, firmware or other storage media. The invention may also be embodied on a computer readable modulated carrier signal.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

The embodiments of the invention in which an exclusive property or privilege is claimed are defined as follows:

1. A method of selecting recipients of an e-mail message for transmission by a recipient computer in reply to a received e-mail message comprising:
i) storing said received e-mail message in the memory of said recipient computer;
ii) parsing the contents of the said received email for e-mail addresses and forming a list of said parsed e-mail addresses;
iii) displaying said list of parsed e-mail addresses; and
iv) forming a reply e-mail message to recipients selected from said list by said user.

2. The method of claim 1 wherein said received e-mail message is a multi-party e-mail.

3. The method of claim 1 wherein said list of parsed e-mail addresses is displayed in response to an action by a user.

4. The method of claim 3 wherein said user action comprises initiating a reply message.

5. The method of claim 1 wherein said recipient computer parses said received e-mail message automatically prior to said user action.

6. The method of claim 1 wherein said recipient computer parses said received e-mail message automatically upon receipt of said message.

7. The method of claim 1 wherein said recipient computer loads and displays said received email for viewing by said user prior to said parsing step.

8. The method of claim 1 wherein prior to said parsing step said user requests a list of potential reply e-mail addresses.

9. The method of claim 1 wherein said response message is formed by auto-populating SMTP headers with said list of e-mail addresses

10. The method of claim 1 wherein said response message is formed by auto-populating user interface graphical elements.

11. A computer program product for selecting recipients of an e-mail message for transmission by a recipient computer in reply to a received e-mail message said computer program product comprising:
a computer usable medium having computer readable program code means embodied in said medium for:
i) storing said received e-mail message in the memory of said recipient computer;
ii) parsing the contents of the said received email for e-mail addresses and forming a list of said parsed e-mail addresses;
iii) displaying said list of parsed e-mail addresses; and
iv) forming a reply e-mail message to recipients selected from said list by said user.

12. The computer program product of claim 11 wherein said received e-mail message is a multi-party e-mail.

13. The computer program product of claim 11 wherein said list of parsed e-mail addresses is displayed in response to an action by a user.

14. The computer program product of claim 13 wherein said user action comprises initiating a reply message.

15. The computer program product of claim 11 wherein said recipient computer parses said received e-mail message automatically prior to said user action.

16. The computer program product of claim 11 wherein said recipient computer parses said received e-mail message automatically upon receipt of said message

17. The computer program product of claim 11 wherein said recipient computer loads and displays said received email for viewing by said user prior to said parsing step.

18. The computer program product of claim 11 wherein prior to said parsing step said user requests a list of potential reply e-mail addresses.

19. The computer program product of claim 11 wherein said response message is formed by auto-populating SMTP headers with said list of e-mail addresses.

20. The computer program product of claim 11 wherein said response message is formed by auto-populating user interface graphical elements.

21. An article comprising:
a computer readable modulated carrier signal;
means embedded in said signal for selecting recipients of an e-mail message for transmission by a recipient computer in reply to a received e-mail message by i) storing said received email message in the memory of said recipient computer;
ii) parsing the contents of the said received email for e-mail addresses and forming a list of said parsed e-mail addresses;
iii) displaying said list of parsed e-mail addresses; and
iv) forming a reply e-mail message to recipients selected from said list by said user.

22. The article of claim 21 wherein said received e-mail message is a multi-party e-mail.

23. The article of claim 21 wherein said list of parsed e-mail addresses is displayed in response to an action by a user.

24. The article of claim 23 wherein said user action comprises initiating a reply message.

25. The article of claim 21 wherein said recipient computer parses said received e-mail message automatically prior to said user action.

26. The article of claim 21 wherein said recipient computer parses said received e-mail message automatically upon receipt of said message.

27. The article of claim 21 wherein said recipient computer loads and displays said received email for viewing by said user prior to said parsing step.

28. The article of claim 21 wherein prior to said parsing step said user requests a list of potential reply e-mail addresses.

29. The article of claim 21 wherein said response message is formed by auto-populating SMTP headers with said list of e-mail addresses.

30. The article of claim 21 wherein said response message is formed by auto-populating user interface graphical elements.
